(19) United States
(12) Patent Application Publication
(10) Pub. No.: US 2020/0290427 A1
(43) Pub. Date: Sep. 17, 2020

(54) CONTROL DEVICE OF VEHICLE COOLING DEVICE

(71) Applicant: TOYOTA JIDOSHA KABUSHIKI KAISHA, Toyota-shi (JP)

(72) Inventor: Masato WATANABE, Toyota-shi (JP)

(73) Assignee: TOYOTA JIDOSHA KABUSHIKI KAISHA, Toyota-shi (JP)

(21) Appl. No.: 16/813,950

(22) Filed: Mar. 10, 2020

(30) Foreign Application Priority Data
Mar. 13, 2019 (JP) 2019-046501

(51) Int. Cl. B60H 1/00; B60R 16/04; H01M 10/6568; H01M 10/613; H01M 10/625; H01M 10/63

(52) U.S. Cl. CPC B60H 1/00735; B60R 16/04; H01M 10/6568; H01M 10/613; H01M 2220/20; H01M 10/63; B60H 1/00278; B60H 1/00657; B60H 1/00885; H01M 10/625

(57) ABSTRACT

A control device of a vehicle cooling device includes a drive-unit-cooling circuit cooling a drive unit with a flowing coolant, a storage-battery-cooling circuit cooling a storage battery with a flowing coolant, and a heat exchanger cooling the coolant returning from the drive-unit-cooling circuit and the coolant returning from the storage-battery-cooling circuit, the vehicle cooling device sending out the coolant cooled by the heat exchanger to the drive-unit-cooling circuit and the storage-battery-cooling circuit, wherein, when the storage battery is in a charging state, a flow of the coolant flowing through the drive-unit-cooling circuit is stopped.

This application claims priority from Japanese Patent Application No. 2019-046501 filed on Mar. 13, 2019, the disclosure of which is herein incorporated by reference in its entirety.

### FIELD OF THE INVENTION

The present invention relates to a vehicle cooling device cooling a drive unit and a storage battery and relates to a technique of suitably improving a cooling performance for the storage battery when the storage battery is in a charging state.

### DESCRIPTION OF THE RELATED ART

A vehicle cooling device cooling both a drive unit and a storage battery is known. For example, this corresponds to a vehicle cooling device described in Patent Document 1. The vehicle cooling device described in Patent Document 1 includes a cooling circuit cooling both a drive unit including a drive motor and a drive circuit, for example, and a storage battery with a flowing coolant, a heat exchanger cooling the coolant returning from the cooling circuit, and an electric pump sending out the coolant cooled by the heat exchanger to the cooling circuit. Patent Document 1 describes that when the storage battery is in a charging state, a flow rate of the coolant sent out to the cooling circuit by the electric pump is changed depending on a temperature of the coolant flowing through the cooling circuit.

### PRIOR ART DOCUMENT

### Patent Document

Patent Document 1: Japanese Laid-Open Patent Publication No. 2015-21406

### SUMMARY OF THE INVENTION

### Technical Problem

However, since the vehicle cooling device as described in Patent Document 1 cools both the drive unit and the storage battery with the coolant flowing through the cooling circuit, the vehicle cooling device has a problem that when the storage battery is in a charging state and the storage battery is desirably preferentially cooled, a cooling performance for cooling the storage battery is deteriorated by a heat transferred from the drive unit to the coolant. This may cause a charging failure in the storage battery, such as limitation of charge amount and extension of charging time.

The present invention was conceived in view of the situations and it is therefore an object of the present invention to provide a control device of a vehicle cooling device configured to suitably improve a cooling performance of a storage battery when the storage battery is in a charging state.

### Solution to Problem

To achieve the above object, a first aspect of the present invention provides a control device of a vehicle cooling device including (a) a drive-unit-cooling circuit cooling a drive unit with a flowing coolant, a storage-battery-cooling circuit cooling a storage battery with a flowing coolant, and a heat exchanger cooling the coolant returning from the drive-unit-cooling circuit and the coolant returning from the storage-battery-cooling circuit, the vehicle cooling device sending out the coolant cooled by the heat exchanger to the drive-unit-cooling circuit and the storage-battery-cooling circuit, wherein (b) when the storage battery is in a charging state, a flow of the coolant flowing through the drive-unit-cooling circuit is stopped.

A second aspect of the present invention provides the control device of the vehicle cooling device recited in the first aspect of the invention, wherein when the storage battery is in a non-charging state and a state of charge of the storage battery is equal to or less than a first value set in advance, the flow of the coolant flowing through the drive-unit-cooling circuit is stopped.

A third aspect of the present invention provides the control device of the vehicle cooling device recited in the second aspect of the invention, wherein when the storage battery is in the non-charging state and the state of charge of the storage battery is greater than the first value and equal to or less than a second value set in advance to be greater than the first value, the coolant is circulated in the drive-unit-cooling circuit.

A fourth aspect of the present invention provides the control device of the vehicle cooling device recited in any one of the first to third aspects of the invention, wherein when the storage battery is in the non-charging state and the temperature of the storage battery is equal to or greater than a predetermined temperature set in advance, the flow of the coolant flowing through the drive-unit-cooling circuit is stopped.

A fifth aspect of the present invention provides the control device of the vehicle cooling device recited in any one of the first to fourth aspects of the invention, wherein the coolant is a cooling water.

A sixth aspect of the present invention provides the control device of the vehicle cooling device recited in any one of the first to fifth aspects of the invention, wherein (a) the vehicle cooling device includes a first pump sending out the coolant cooled by the heat exchanger into the drive-unit-cooling circuit and a second pump sending out the coolant cooled by the heat exchanger into the storage-battery-cooling circuit, and wherein (b) when the storage battery is in the charging state, the first pump is stopped to stop the flow of the coolant in the drive-unit-cooling circuit.

A seventh aspect of the present invention provides the control device of the vehicle cooling device recited in the sixth aspect of the invention, wherein when the storage battery is in the non-charging state and the state of charge of the storage battery is greater than a first value set in advance and equal to or less than a second value set in advance to be greater than the first value, the first pump is driven to circulate the coolant in the drive-unit-cooling circuit.

### Advantageous Effects of Invention

According to the control device of the vehicle cooling device recited in the first aspect of the invention, when the storage battery is in the charging state, the flow of the coolant flowing through the drive-unit-cooling circuit is stopped. Therefore, when the storage battery is in the charging state, the coolant having heat transferred from the drive unit does not return from the drive-unit-cooling circuit to the heat exchanger, so that the cooling performance for the storage battery can suitably be improved when the storage battery is in the charging state.

According to the control device of the vehicle cooling device recited in the second aspect of the invention, when the storage battery is in the non-charging state, and the state of charge of the storage battery is equal to or less than the first value, the flow of the coolant flowing through the drive-unit-cooling circuit is stopped. Therefore, even though the storage battery is in the non-charging state, when the state of charge of the storage battery is equal to or less than the first value so that the storage battery is predicted to be charged in the relatively near future, the cooling performance for the storage battery can be improved before start of charging of the storage battery.

According to the control device of the vehicle cooling device recited in the third aspect of the invention, when the storage battery is in the non-charging state, and the state of charge of the storage battery is greater than the first value and equal to or less than the second value, the coolant is circulated in the drive-unit-cooling circuit. Therefore, when the state of charge of the storage battery is greater than the first value and equal to or less than the second value and it is predicted that the storage battery is not charged in the relatively near future, the drive unit can be cooled, and therefore, both the cooling performance for the storage battery and the cooling performance for the drive unit can be improved when the storage battery is in the charging state.

According to the control device of the vehicle cooling device recited in the fourth aspect of the invention, when the storage battery is in the non-charging state, and the temperature of the storage battery is equal to or greater than the predetermined temperature, the flow of the coolant flowing through the drive-unit-cooling circuit is stopped. Therefore, when the temperature of the storage battery is equal to or greater than the predetermined temperature, the cooling performance for the storage battery can be improved before charging of the storage battery, and the storage battery can suitably be cooled.

According to the control device of the vehicle cooling device recited in the fifth aspect of the invention, the coolant is the cooling water, so that both the drive unit and the storage battery can suitably be cooled.

According to the control device of the vehicle cooling device recited in the sixth aspect of the invention, (a) the vehicle cooling device includes the first pump circulating the coolant cooled by the heat exchanger into the drive-unit-cooling circuit, and the second pump circulating the coolant cooled by the heat exchanger into the storage-battery-cooling circuit, and (b) when the storage battery is in the charging state, the first pump is stopped to stop the flow of the coolant in the drive-unit-cooling circuit. In other words, by stopping the first pump, the flow of the coolant in the drive-unit-cooling circuit can suitably be stopped when the storage battery is in the charging state. As a result, the coolant having heat transferred from the drive unit does not return to the heat exchanger from the drive-unit-cooling circuit, so that the cooling performance for the storage battery can suitably be improved when the storage battery is in the charging state.

According to the control device of the vehicle cooling device recited in the seventh aspect of the invention, when the storage battery is in the non-charging state, and the state of charge of the storage battery is greater than the first value and equal to or less than the second value, the first pump is driven to circulate the coolant into the drive-unit-cooling circuit. In other words, by driving the first pump, the coolant can suitably be circulated into the drive-unit-cooling circuit when it is predicted that the storage battery is not charged in the relatively near future. As a result, the drive unit can be cooled, so that both the cooling performance for the storage battery and the cooling performance for the drive unit can be improved when the storage battery is in the charging state.

### BRIEF DESCRIPTION OF DRAWINGS

FIG. 1 is a diagram for explaining a general configuration of an electric automobile to which the present invention is preferably applied.

FIG. 2 is a diagram for explaining a configuration of a power train unit disposed in the electric automobile of FIG. 1.

FIG. 3 is a functional block diagram for explaining main portions of a control function included in an electronic control device of the electric automobile.

FIG. 4 is a flowchart for explaining an example of a control operation of a switching control of switching a drive state of a PTU cooling device in the electronic control device of FIG. 3 during parking, for example.

FIG. 5 is a figure showing another example of the present invention and is a flowchart for explaining another example of the control operation of the switching control of switching the drive state of the PTU cooling device during parking.

FIG. 6 is a flowchart for explaining another example of the control operation of the switching control of switching a drive state of the PTU cooling device during parking.

FIG. 7 is a flowchart for explaining another example of the control operation of the switching control of switching a drive state of the PTU cooling device during parking.

FIG. 8 is a diagram for explaining another configuration of a power train unit disposed in a hybrid vehicle.

### MODES FOR CARRYING OUT THE INVENTION

An example of the present invention will now be described in detail with reference to the drawings.

### EXAMPLE 1

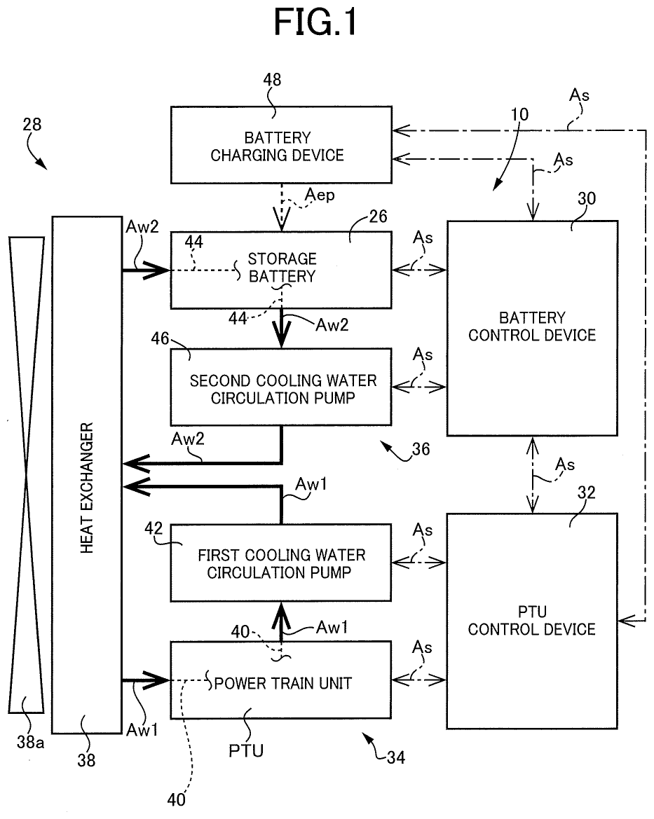

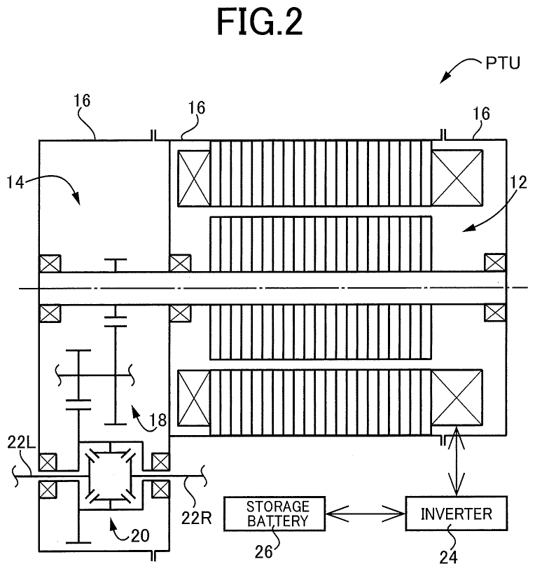

FIG. 1 is a diagram for explaining a general configuration of an electric automobile 10 to which the present invention is applied. FIG. 2 is a diagram for explaining a general configuration of a power train unit (drive unit) PTU disposed in the electric automobile 10 of FIG. 1. The power train unit PTU is a drive unit driving a pair of left and right drive wheels not shown.

As shown in FIG. 2, the power train unit PTU includes an electric motor 12, a power transmission mechanism 14, and a housing case 16. The electric motor 12 is a drive force source for running. The power transmission mechanism 14 transmits a drive force generated by the electric motor 12 to the pair of left and right drive wheels. The housing case 16 houses the electric motor 12, the power transmission mechanism 14, etc. The power transmission mechanism 14 includes a gear mechanism 18, a differential gear device 20, and a pair of left and right drive shafts 22L, 22R. The gear mechanism 18 is coupled to the electric motor 12 in a power transmittable manner. The differential device 20 is coupled to the gear mechanism 18 in a power transmittable manner. The drive shafts 22L, 22R are integrally fixed to the drive wheels and coupled to the differential device 20 in a power transmittable manner.

The electric motor 12 is a so-called motor generator having a function of a motor generating a mechanical power from an electric energy (electric power) and a function of a generator generating an electric energy from a mechanical power. As shown in FIG. 2, the electric motor 12 generates the drive force for running from an electric power supplied from a storage battery 26 via an inverter 24. The electric motor 12 converts a driven force input from the drive wheel side through regeneration into an electric power and charges the storage battery 26 with the electric power via the inverter 24. The storage battery 26 is a secondary battery, for example, a nickel-metal hydride battery or a lithium-ion battery. The power train unit PTU includes the inverter 24.

As shown in FIG. 1, the electric automobile 10 includes the power train unit PTU, the storage battery 26, a cooling device (vehicle cooling device) 28, a battery control device 30, a PTU control device 32, etc. The cooling device 28 includes a PTU cooling device 34, a battery cooling device 36, and a heat exchanger 38.

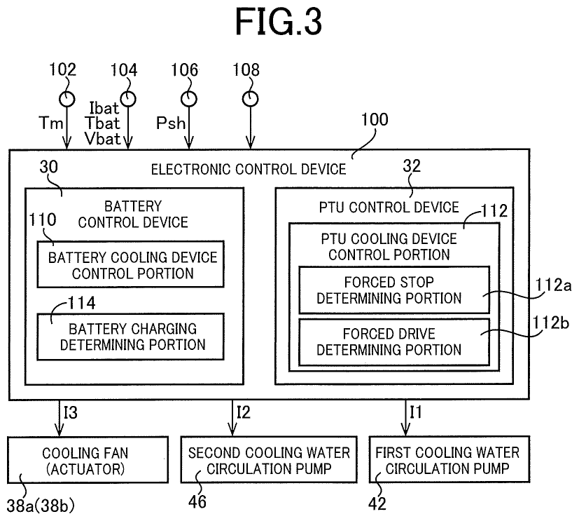

As shown in FIG. 1, the PTU cooling device 34 includes a PTU cooling circuit (drive-unit-cooling circuit) 40 cooling the power train unit PTU with flowing cooling water (coolant) W therein, and a first cooling water circulation pump (first pump) 42 sending out the cooling water W cooled by the heat exchanger 38 to the PTU cooling circuit 40. Arrows Awl of solid lines of FIG. 1 are arrows indicative of a flow of the cooling water W flowing in the PTU cooling circuit 40. The PTU control device 32 is an electronic control device controlling, for example, the first cooling water circulation pump 42 and the power train unit PTU, for example, the electric motor 12. The first cooling water circulation pump 42 is an electric pump driven by a first drive current (command signal) I1 (see FIG. 3) supplied from the PTU control device 32. The cooling water W is, for example, long-life coolant or antifreeze. Therefore, in the PTU cooling device 34, the cooling water W flows in the PTU cooling circuit 40 when the first cooling water circulation pump 42 is driven by the first drive current I1 from the PTU control device 32. As a result, heat of the power train unit PTU, for example, the electric motor 12 and the inverter 24, is reduced by the cooling water W, and the power train unit PTU is cooled.

As shown in FIG. 1, the battery cooling device 36 includes a storage-battery-cooling circuit 44 cooling the storage battery 26 with the flowing cooling water W, and a second cooling water circulation pump (second pump) 46 sending out the cooling water W cooled by the heat exchanger 38 to the storage-battery-cooling circuit 44. Arrows Aw2 of solid lines of FIG. 1 are arrows indicative of a flow of the cooling water W flowing in the storage-battery-cooling circuit 44. The battery control device 30 is an electronic control device controlling, for example, the drive of the second cooling water circulation pump 46 and discharge or charge etc. of the storage battery 26. The second cooling water circulation pump 46 is an electric pump driven by a second drive current (command signal) 12 (see FIG. 3) supplied from the battery control device 30. Therefore, in the battery cooling device 36, the cooling water W flows in the storage-battery-cooling circuit 44 when the second cooling water circulation pump 46 is driven by the second drive current I2 from the battery control device 30. As a result, the heat of the storage battery 26 is reduced by the cooling water W, and the storage battery 26 is cooled.

As shown in FIG. 1, the heat exchanger 38 cools the cooling water W returning from the PTU cooling circuit 40 and the cooling water W returning from the storage-battery-cooling circuit 44. The heat exchanger 38 allows air flowing from the outside of the electric automobile 10 and the cooling water W to exchange heat and thereby cools the cooling water W. Specifically, the heat exchanger 38 causes the cooling water W returning from the PTU cooling circuit 40 and the cooling water W returning from the storage-battery-cooling circuit 44 to pass through a common radiator in a mixed state so that the water is cooled by air. The heat exchanger 38 is provided with a cooling fan 38a for promoting cooling of the cooling water W. For example, when at least one of the PTU cooling device 34 and the battery cooling device 36 is driven, the cooling fan 38a is rotationally driven by an electronic control device (control device) 100 (see FIG. 3).

A battery charging device 48 shown in FIG. 1 is a quick charger or a normal charger disposed in a place where a vehicle is parked, for example. The quick charger is a device converting AC power supplied from an external AC power source of, for example, three-phase AC 200 V, into DC power and supplying the converted DC power, for example, at up to 500V, via a DC charging cable not shown to the storage battery 26. The quick charger complies with the “CHAdeMO (registered trademark)” standard (hereinafter referred to as “CHAdeMO standard”). The CHAdeMO standard is an international standard for DC quick charging. The normal charger is a device supplying, for example, 200 V AC power supplied from an external AC power source of, for example, single-phase AC 200 V, via an AC charging cable not shown and the inverter 24 to the storage battery 26. An arrow Aep of a broken line of FIG. 1 is an arrow indicative of a flow of electric power supplied from the battery charging device 48. Arrows As of dashed-dotted lines of FIG. 1 are arrows indicative of a flow of a command signal in the electric automobile 10 and a flow of a command signal between the electric automobile 10 and the battery charging device 48.

As shown in FIG. 3, the electronic control device 100 is configured to include a so-called microcomputer including a CPU, a RAM, a ROM, and an I/O interface, for example, and the CPU executes signal processes in accordance with a program stored in advance in the ROM, while utilizing a temporary storage function of the RAM, to provide various controls of the electric automobile 10. The electronic control device 100 includes the battery control device 30 and the PTU control device 32. The electronic control device 100 is supplied with various input signals detected by sensors disposed in the electric automobile 10. For example, the signals input to the electronic control device 100 include: a signal indicative of a temperature Tm [° C.] of the power train unit PTU, for example, the temperature Tm [° C.] of the electric motor 12, detected from a temperature sensor 102; signals indicative of a battery temperature That [° C], a battery input/output current Ibat [A], a battery voltage Vbat [V], etc. of the storage battery 26 detected by a battery sensor 104; a signal indicative of a shift operation position Psh of a shift lever (not shown) detected from a shift position sensor 106; and an ignition-on (IGON) signal for powering on the electric automobile 10 and an ignition-off (IGOFF) signal for powering off the electric automobile 10 detected from an ignition switch 108.

The electronic control device 100 supplies various output signals to devices disposed in the electric automobile 10. For example, the signals supplied from the electronic control device 100 to the portions include: the first drive current I1 [A] supplied to the first cooling water circulation pump 42 for driving the PTU cooling device 34, i.e., the first cooling water circulation pump 42; the second drive current I2 [A] supplied to the second cooling water circulation pump 46 for driving the battery cooling device 36, i.e., the second cooling water circulation pump 46; and a third drive current I3 [A] supplied to an actuator 38b (see FIG. 3) disposed in the cooling fan 38a for rotationally driving the cooling fan 38a of the heat exchanger 38.

As shown in FIG. 3, the electronic control device 100 includes a battery cooling device control portion 110, a PTU cooling device control portion 112, and a battery charging determining portion 114. The battery cooling device control portion 110 switches a drive state of the battery cooling device 36 in accordance with the battery temperature That [° C.] of the storage battery 26. For example, when the battery temperature Tbat [° C.] is equal to or greater than a first predetermined temperature Tbat1 [° C.] set in advance, the battery cooling device control portion 110 supplies the second drive current I2 [A] to the second cooling water circulation pump 46 of the battery cooling device 36 and supplies the third drive current I3 [A] to the actuator 38b of the cooling fan 38a. As a result, both the second cooling water circulation pump 46 and the cooling fan 38a are driven, and the cooling water W cooled by the heat exchanger 38 flows through the storage-battery-cooling circuit 44 so that the storage battery 26 is cooled. For example, when the battery temperature Tbat [° C.] of the storage battery 26 detected from the battery sensor 104 is equal to or less than a second predetermined temperature Tbat2 [° C.] set in advance, the battery cooling device control portion 110 stops supply of the second drive current I2 [A] supplied to the second cooling water circulation pump 46 and stops supply of the third drive current I3 [A] supplied to the actuator 38b of the cooling fan 38a. This stops the second cooling water circulation pump 46 and stops the flow of the cooling water W flowing through the storage-battery-cooling circuit 44. The second predetermined temperature Tbat2 [° C.] is a temperature lower than the first predetermined temperature Tbat1 [° C].

The PTU cooling device control portion 112 switches a drive state of the PTU cooling device 34 in accordance with the temperature Tm [° C.] of the power train unit PTU, for example, the temperature Tm [° C.] of the electric motor 12. For example, when the temperature Tm [° C.] is equal to or greater than a first predetermined temperature Tm1 [° C.] set in advance, the PTU cooling device control portion 112 supplies the first drive current I1 [A] to the first cooling water circulation pump 42 of the PTU cooling device 34 and supplies the third drive current I3 [A] to the actuator 38b of the cooling fan 38a. As a result, both the first cooling water circulation pump 42 and the cooling fan 38a are driven, and the cooling water W cooled by the heat exchanger 38 flows through the PTU cooling circuit 40 so that the power train unit PTU is cooled. For example, when the temperature Tm [° C.] of the electric motor 12 detected from the temperature sensor 102 is equal to or less than a second predetermined temperature Tm2 [° C.] set in advance, the PTU cooling device control portion 112 stops supply of the first drive current I1 [A] supplied to the first cooling water circulation pump 42 and stops supply of the third drive current I3 [A] supplied to the actuator 38b of the cooling fan 38a. This stops the first cooling water circulation pump 42 and stops the flow of the cooling water W flowing through the PTU cooling circuit 40. The second predetermined temperature Tm2 [° C.] is a temperature lower than the first predetermined temperature Tml [° C]. In the battery cooling device control portion 110 and the PTU cooling device control portion 112, when at least one of the first drive current I1 [A] and the second drive current I2 [A] is supplied, the third drive current I3 [A] is supplied, and when the supplies of both of the first drive current I1 [A] and the second drive current I2 [A] are stopped, the supply of the third drive current I3 [A] is stopped.

The battery charging determining portion 114 determines whether the storage battery 26 is in a charging state or the storage battery 26 is in a non-charging state. In other words, the battery charging determining portion 114 determines whether the storage battery 26 is being charged or not. For example, in the case that the shift operation position Psh is a parking position P, that the electric automobile 10 is powered off by the ignition switch 108, and that a connector disposed at an end portion of the DC charging cable of the quick charger is connected to a quick charging connector disposed on the electric automobile 10 so that DC power is supplied from the quick charger to the storage battery 26, the battery charging determining portion 114 determines that the storage battery 26 is in the charging state. The charging state is a state in which the storage battery 26 is charged with an electric power supplied to the storage battery 26 from the battery charging device 48, for example, the quick charger, regardless of an amount of electric power discharged from the storage battery 26. The non-charging state is a state in which no electric power is supplied to the storage battery 26 from the battery charging device 48, for example, the quick charger, so that the storage battery 26 is not charged, regardless of an amount of electric power discharged from the storage battery 26. When the shift lever is operated to the parking position P, a parking lock mechanically preventing rotation of the drive wheels is activated by a parking mechanism (not shown) disposed in the electric automobile 10.

The PTU cooling device control portion 112 includes a forced stop determining portion 112a and a forced drive determining portion 112b. The forced stop determining portion 112a determines whether the PTU cooling device 34 needs to be forcibly stopped for improving a cooling performance of the battery cooling device 36 for the storage battery 26. For example, when the battery charging determining portion 114 determines that the storage battery 26 is in the charging state, the forced stop determining portion 112a determines that the PTU cooling device 34 needs to be forcibly stopped. Additionally, when the battery charging determining portion 114 determines that the storage battery 26 is in the non-charging state and it is determined that a state of charge SOC [%] of the storage battery 26 at the time of determination of the storage battery 26 being in the non-charging state by the battery charging determining portion 114 is equal to or less than a first value SOC1 [%] set in advance, the forced stop determining portion 112a determines that the PTU cooling device 34 needs to be forcibly stopped. The first value SOC1 [%] is a value of the state of charge SOC [%] at which it is predicted that the storage battery 26 is highly likely to be charged in a relatively near future. The state of charge SOC [%] of the storage battery 26 is calculated from the battery temperature Tbat [° C], the battery input/output current That [A], and the battery voltage Vhat [V] of the storage battery 26 detected from the battery sensor 104 at the time of determination of the storage battery 26 being in the non-charging state by the battery charging determining portion 114. Additionally, when the battery charging determining portion 114 determines that the storage battery 26 is in the non-charging state and it is determined that the battery temperature Tbat [° C.] of the storage battery 26 at the time of determination of the storage battery 26 being in the non-charging state by the battery charging determining portion 114 is equal to or greater than a third predetermined temperature (predetermined temperature) Tbat3 [° C.] set in advance, the forced stop determining portion 112a determines that the PTU cooling device 34 needs to he forcibly stopped. The third predetermined temperature Tbat3 [° C.] is a temperature higher than the first predetermined temperature Tbat1 [° C].

The forced drive determining portion 112b determines whether the PTU cooling device 34 needs to be forcibly driven so as to improve a cooling performance of the PTU cooling device 34 for the power train unit PTU while the cooling performance of the battery cooling device 36 for the storage battery 26 is kept being improved. For example, when the battery charging determining portion 114 determines that the storage battery 26 is in the non-charging state and it is determined that the state of charge SOC [%] of the storage battery 26 at the time of determination of the storage battery 26 being in the non-charging state by the battery charging determining portion 114 is greater than the first SOC1 [%] and equal to or less than a second value SOC2 [%] set in advance, the forced drive determining portion 112b determines that the PTU cooling device 34 needs to be forcibly driven. The second value SOC2 [%] is a value of the state of charge SOC [%] larger than the first value SOC1 [%], and the second value SOC2 [%] is the state of charge SOC [%] at which it is predicted that the storage battery 26 is less likely to be charged in a relatively near future.

When the forced stop determining portion 112a determines that the PTU cooling device 34 needs to be forcibly stopped, the PTU cooling device control portion 112 stops the supply of the first drive current I1 [A] to the PTU cooling device 34 (the first cooling water circulation pump 42) regardless of whether the first drive current I1 [A] is being supplied-to the PTU cooling device 34. This stops the first cooling water circulation pump 42 and stops the flow of the cooling water W flowing through the PTU cooling circuit 40.

When the forced drive determining portion 112b determines that the PTU cooling device 34 needs to be forcibly driven, the PTU cooling device control portion 112 supplies the first drive current I1 [A] to the PTU cooling device 34 regardless of whether the first drive current I1 [A] is being supplied to the PTU cooling device 34. As a result, the first cooling water circulation pump 42 is driven, and the cooling water W flows in the PTU cooling circuit 40. When the forced drive determining portion 112b determines that the PTU cooling device 34 needs to be forcibly driven and the temperature Tm [° C.] of the electric motor 12 detected from the temperature sensor 102 is equal to or less than a third predetermined temperature Tm3 [° C.] set in advance, the PTU cooling device control portion 112 stops the supply of the first drive current I1 [A] to the PTU cooling device 34. The third predetermined temperature Tm3 [° C.] is a temperature lower than the second predetermined temperature Tm2 [° C].

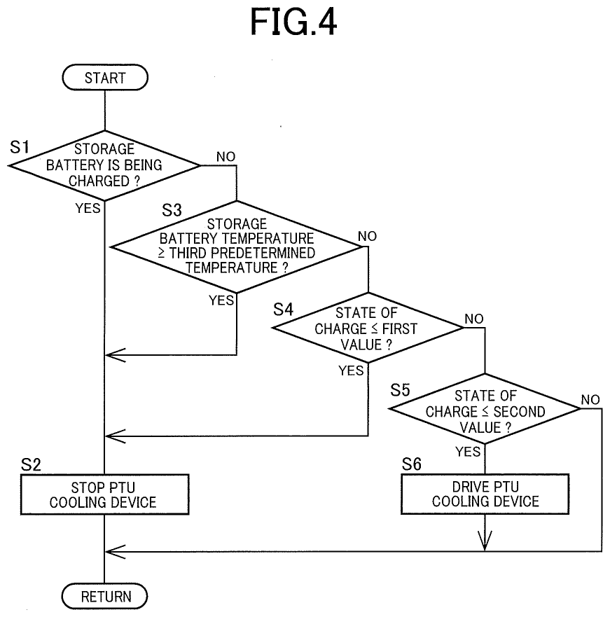

FIG. 4 is a flowchart for explaining an example of a control operation in the electronic control device 100 of a switching control of the drive states of the PTU cooling device 34 during parking, for example.

First, at step (hereinafter, step will be omitted) S1 corresponding to functions of the battery charging determining portion 114 and the forced stop determining portion 112a, it is determined whether the storage battery 26 is being charged, i.e., whether the storage battery 26 is in the charging state. In other words, at S1, it is determined whether the PTU cooling device 34 needs to be forcibly stopped. If the determination of S1 is affirmative, i.e., if the storage battery 26 is in the charging state, S2 corresponding to the function of the PTU cooling device control portion 112 is executed. If the determination of S1 is negative, i.e., if the storage battery 26 is in the non-charging state, S3 corresponding to the function of the forced stop determining portion 112a is executed.

At S3, it is determined whether the battery temperature Tbat [° C.] of the storage battery 26 is equal to or greater than the third predetermined temperature Tbat3 [° C]. In other words, at S3, it is determined whether the PTU cooling device 34 needs to be forcibly stopped. If the determination of S3 is affirmative, i.e., if the battery temperature Tbat [° C.] of the storage battery 26 is equal to or greater than the third predetermined temperature Tbat3 [° C], S2 is executed. If the determination of S3 is negative, i.e., if the battery temperature Tbat [° C.] of the storage battery 26 is lower than the third predetermined temperature Tbat3 [° C], S4 corresponding to the function of the forced stop determining portion 112a is executed.

At S4, it is determined whether the state of charge SOC [%] of the storage battery 26 is equal to or less than the first value SOC1 [%]. In other words, at S4, it is determined whether the PTU cooling device 34 needs to be forcibly stopped. If the determination of S4 is affirmative, i.e., if the state of charge SOC [%] of the storage battery 26 is equal to or less than the first value SOC1 [%], S2 is executed. If the determination of S4 is negative, i.e., if the state of charge SOC [%] of the storage battery 26 is greater than the first value SOC1 [%], S5 corresponding to function of the forced drive determining portion 112b is executed.

At S5, it is determined whether the state of charge SOC [%] of the storage battery 26 is equal to or less than the second value SOC2 [%]. In other words, at S5, it is determined whether the PTU cooling device 34 needs to be forcibly driven. If the determination of S5 is affirmative, i.e., if the state of charge SOC [%] of the storage battery 26 is equal to or less than the second value SOC2 [%], S6 corresponding to the function of the PTU cooling device control portion 112 is executed. If the determination of S5 is negative, i.e., if the state of charge SOC [%] of the storage battery 26 is greater than the second value SOC2 [%], this routine is terminated.

At S2, the supply of the first drive current I1 [A] to the PTU cooling device 34 is stopped regardless of whether the first drive current I1 [A] is supplied to the PTU cooling device 34. In other words, at S2, the PTU cooling device 34 is forcibly stopped. At S6, the first drive current I1 [A] is supplied to the PTU cooling device 34 regardless of whether the first drive current I1 [A] is supplied to the PTU cooling device 34. In other words, at S6, the PTU cooling device 34 is forcibly driven.

As described above, according to the electronic control device 100 of the cooling device 28 of this example, when the storage battery 26 is in the charging state, the flow of the cooling water W flowing through the PTU cooling circuit 40 is stopped. Therefore, when the storage battery 26 is in the charging state, the cooling water W having heat transferred from the power train unit PTU does not return from the PTU cooling circuit 40 to the heat exchanger 38, so that the cooling performance for the storage battery 26 can suitably be improved.

According to the electronic control device 100 of the cooling device 28 of this example, when the storage battery 26 is in the non-charging state, and the state of charge SOC [%] of the storage battery 26 is equal to or less than the first value SOC1 [%] set in advance, the flow of the cooling water W flowing through the PTU cooling circuit 40 is stopped. Therefore, even though the storage battery 26 is in the non-charging state, when the state of charge SOC [%] of the storage battery 26 is equal to or less than the first value SOC1 [%] so that the storage battery 26 is predicted to be charged in the relatively near future, the cooling performance for the storage battery 26 can be improved before start of charging of the storage battery 26.

According to the electronic control device 100 of the cooling device 28 of this example, when the storage battery 26 is in the non-charging state, and the state of charge SOC [%] of the storage battery 26 is greater than the first value SOC1 [%] and equal to or less than the second value SOC2 [%], the cooling water W is circulated in the PTU cooling circuit 40. Therefore, when the state of charge SOC [%] of the storage battery 26 is greater than the first value SOC1 [%] and equal to or less than the second value SOC2 [%] and it is predicted that the storage battery 26 is not charged in the relatively near future, the power train unit PTU can be cooled, and therefore, both the cooling performance for the storage battery 26 and the cooling performance for the power train unit PTU can be improved when the storage battery 26 is in the charging state.

According to the electronic control device 100 of the cooling device 28 of this example, when the storage battery 26 is in the non-charging state, and the battery temperature Tbat [° C.] of the storage battery 26 is equal to or greater than the third predetermined temperature Tbat3 [° C.] set in advance, the flow of the cooling water W flowing through the PTU cooling circuit 40 is stopped. Therefore, when the battery temperature Tbat [° C.] of the storage battery 26 is equal to or greater than the third predetermined temperature Tbat3 [° C], the cooling performance for the storage battery 26 can be improved before charging of the storage battery 26, and the storage battery 26 can suitably be cooled.

According to the electronic control device 100 of the cooling device 28 of this example, the coolant flowing through the PTU cooling circuit 40 and the storage-battery-cooling circuit 44 is the cooling water W, so that both the power train unit PTU and the storage battery 26 can suitably be cooled.

According to the electronic control device 100 of the cooling device 28 of this example, the cooling device 28 includes the first cooling water circulation pump 42 circulating the cooling water W cooled by the heat exchanger 38 into the PTU cooling circuit 40, and the second cooling water circulation pump 46 circulating the cooling water W cooled by the heat exchanger 38 into the storage-battery-cooling circuit 44, and when the storage battery 26 is in the charging state, the first cooling water circulation pump 42 is stopped to stop the flow of the cooling water W through the PTU cooling circuit 40. In other words, by stopping the first cooling water circulation pump 42, the flow of the cooling water W in the PTU cooling circuit 40 can suitably be stopped when the storage battery 26 is charged. As a result, the cooling water W having heat transferred from the power train unit PTU does not return to the heat exchanger 38 from the PTU cooling circuit 40, so that the cooling performance for the storage battery 26 can suitably be improved when the storage battery 26 is in the charging state.

According to the electronic control device 100 of the cooling device 28 of this example, when the storage battery 26 is in the non-charging state, and the state of charge SOC [%] of the storage battery 26 is greater than the first value SOC1 [%] and equal to or less than the second value SOC2 [%], the first cooling water circulation pump 42 is driven to circulate the cooling water W into the PTU cooling circuit 40. In other words, by driving the first cooling water circulation pump 42, the cooling water W can suitably be circulated into the PTU cooling circuit 40 when it is predicted that the storage battery 26 is not charged in the relatively near future. As a result, the power train unit PTU can be cooled, so that both the cooling performance for the storage battery 26 and the cooling performance for the power train unit PTU can be improved when the storage battery 26 is in the charging state.

Other examples of the present invention will then be described in detail with reference to the drawings. In the following description, the portions common to the examples are denoted by the same reference numerals and will not be described.

### EXAMPLE 2

The electronic control device according to this example is substantially the same as the electronic control device 100 of Example 1 except that one condition is deleted in the forced stop determining portion 112a out of the determination conditions for determining the PTU cooling device 34 needing to be forcibly stopped. Specifically, even when the battery charging determining portion 114 determines that the storage battery 26 is in the non-charging state and the battery temperature Tbat [° C.] of the storage battery 26 is equal to or greater than the third predetermined temperature Tbat3 [° C], the forced stop determining portion 112a determines that the PTU cooling device 34 does not need to be forcibly stopped.

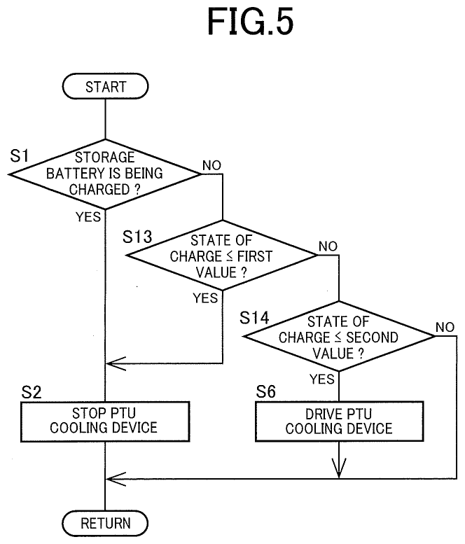

FIG. 5 is a flowchart for explaining an example of the control operation of the switching control of switching the drive state of the PTU cooling device 34 in the electronic control device of this example during parking, for example. S1, S2, S6 shown in FIG. 5 have the same contents as S1, S2, S6 shown in FIG. 4. Therefore, S1, S2, S6 of FIG. 5 will not be described.

At S13 corresponding to the function of the forced stop determining portion 112a, it is determined whether the state of charge SOC [%] of the storage battery 26 is equal to or less than the first value SOC1 [%]. In other words, at S13, it is determined whether the PTU cooling device 34 needs to be forcibly stopped. If the determination of S13 is affirmative, i.e., if the state of charge SOC [%] of the storage battery 26 is equal to or less than the first value SOC1 [%], S2 is executed. When the determination of S13 is negative, i.e., when the state of charge SOC [%] of the storage battery 26 is greater than the first value SOC1 [%], S14 corresponding to the function of the forced drive determining portion 112b is executed.

At S14, it is determined whether the state of charge SOC [%] of the storage battery 26 is equal to or less than the second value SOC2 [%]. In other words, at S14, it is determined whether the PTU cooling device 34 needs to be forcibly driven. If the determination of S14 is affirmative, i.e., if the state of charge SOC [%] of the storage battery 26 is equal to or less than the second value SOC2 [%], S6 is executed. If the determination of S14 is negative, i.e., if the state of charge SOC [%] of the storage battery 26 is greater than the second value SOC2 [%], this routine is terminated.

### EXAMPLE 3

The electronic control device of this example is substantially the same as the electronic control device of Example 2 except that the forced drive determining portion 112b is deleted.

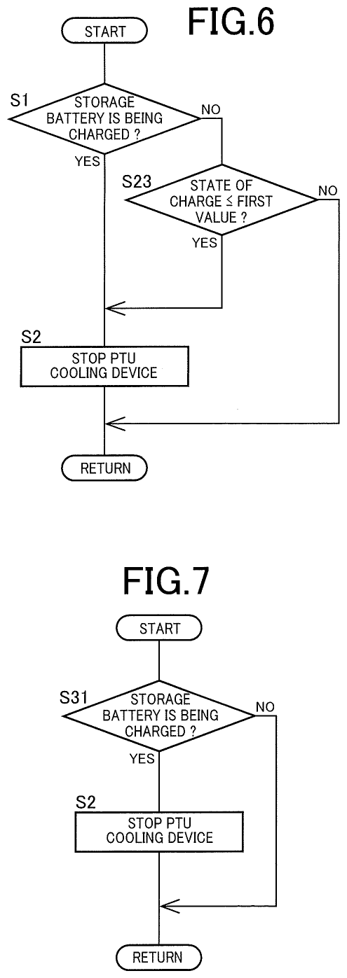

FIG. 6 is a flowchart for explaining an example of the control operation of the switching control of switching the drive state of the PTU cooling device 34 in the electronic control device of this example during parking, for example. S1, S2 shown in FIG. 6 have the same contents as S1, S2 shown in FIG. 5. Therefore, S1, S2 of FIG. 6 will not be described.

At S23 corresponding to the function of the forced stop determining portion 112a, it is determined whether the state of charge SOC [%] of the storage battery 26 is equal to or less than the first value SOC1 [%]. In other words, at S23, it is determined whether the PTU cooling device 34 needs to be forcibly stopped. If the determination of S23 is affirmative, i.e., if the state of charge SOC [%] of the storage battery 26 is equal to or less than the first value SOC1 [%], S2 is executed. When the determination of S23 is negative, i.e., when the state of charge SOC [%] of the storage battery 26 is greater than the first value SOC1 [%], this routine is terminated.

### EXAMPLE 4

The electronic control device according to this example is substantially the same as the electronic control device of Example 3 except that one condition is deleted in the forced stop determining portion 112a out of the determination conditions for determining the PTU cooling device 34 needing to be forcibly stopped. Specifically, even when the battery charging determining portion 114 determines that the storage battery 26 is in the non-charging state and it is determined that the state of charge SOC [%] of the storage battery 26 at the time of determination of the storage battery 26 being in the non-charging state by the battery charging determining portion 114 is equal to or less than the first value SOC1 [%], the forced stop determining portion 112a determines that the PTU cooling device 34 does not need to be forcibly stopped.

FIG. 7 is a flowchart for explaining an example of the control operation of the switching control of switching the drive state of the PTU cooling device 34 in the electronic control device of this example during parking, for example. S2 shown in FIG. 7 has the same content as S2 shown in FIG. 6. Therefore, S2 of FIG. 7 will not be described.

At S31 corresponding to the functions of the battery charging determining portion 114 and the forced stop determining portion 112a, it is determined whether the storage battery 26 is in the charging state. In other words, at S31, it is determined whether the PTU cooling device 34 needs to be forcibly stopped. If the determination of S31 is affirmative, i.e., if the the storage battery 26 is in the charging state, S2 is executed. If the determination of S31 is negative, i.e., if the storage battery 26 is in the non-charging state, this routine is terminated.

### EXAMPLE 5

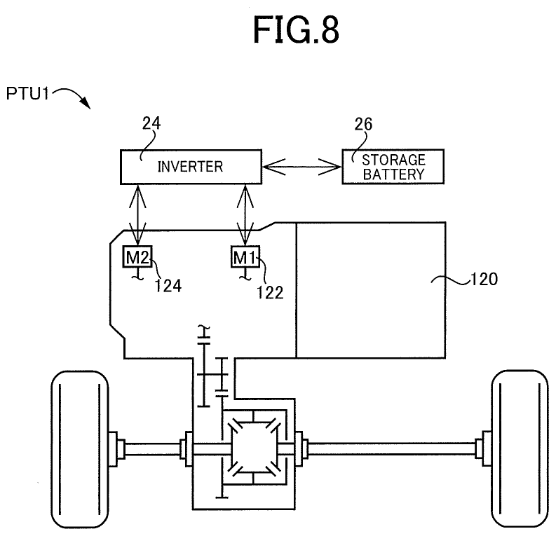

FIG. 8 is a diagram for explaining another example (Example 5) of the present invention and is a diagram for explaining a configuration of a power train unit (drive unit) PTU1 disposed in a hybrid vehicle which is used instead of the power train unit PTU in the previous examples. The hybrid vehicle includes a cooling device (vehicle cooling device). The cooling device is substantially the same as the cooling device 28 of Example 1 except that the power train unit (drive unit) PTU1 is cooled with the cooling water W flowing through the PTU cooling circuit 40, i.e., for example, an engine 120, a first electric motor 122, a second electric motor 124, and the inverter 24 are cooled with the cooling water W flowing through the PTU cooling circuit 40.

Although the examples of the present invention have been described in detail with reference to the drawings, the present invention is also applied in other forms.

For example, in Example 1, the PTU cooling device control portion 112 switches the drive state of the PTU cooling device 34 in accordance with the temperature Tm [° C.] of the electric motor 12. For example, a temperature sensor detecting temperature of the inverter 24 may be disposed in the electric automobile 10, and the drive state of the PTU cooling device 34 may be switched in accordance with the temperature of the inverter 24. In other words, the drive state of the PTU cooling device 34 may be switched in accordance with a temperature of a device constituting the power train unit PTU.

In Example 1, the first cooling water circulation pump 42 is an electric pump driven by the first drive current I1. [A] supplied from the electronic control device 100. For example, the first cooling water circulation pump 42 may be a mechanical pump driven by the rotational drive of the electric motor 12. Specifically, the electric automobile 10 may include an electromagnetic valve configured to supply the cooling water W discharged from the mechanical pump to flow into the PTU cooling circuit 40 and a clutch device disconnecting or connecting a power transmission path between the electric motor 12 and the drive wheels and, for example, when the cooling water W is caused to flow through the PTU cooling circuit 40 during parking, the electronic control device 100 may control the electromagnetic valve and the clutch device and rotationally drive the electric motor 12.

Although the cooling water W is used to flow in the PTU cooling circuit 40 and the storage-battery-cooling circuit 44 in Example 1, a fluid such as oil may be allowed to flow instead of the cooling water W as the coolant, for example.

In Example 1, the battery charging determining portion 114 determines that the storage battery 26 is in the charging state when DC power is supplied from the quick charger to the storage battery 26. However, for example, the battery charging determining portion 114 may determine that the storage battery 26 is in the charging state when DC power is supplied from the normal charger via the inverter 24 to the storage battery 26.

The above description is merely an embodiment and the present invention can be implemented in variously modified and improved forms based on the knowledge of those skilled in the art.

### REFERENCE SIGNS LIST

26: storage battery

28: cooling device (vehicle cooling device)

38: heat exchanger

40: PTU cooling circuit (drive-unit-cooling circuit)

42: first cooling water circulation pump (first pump)

44: storage-battery-cooling circuit

46: second cooling water circulation pump (second pump)

100: electronic control device (control device)

110: battery cooling device control portion

112: PTU cooling device control portion

112a: forced stop determining portion

112b: forced drive determining portion

114: battery charging determining portion

PTU, PTU1: power train unit (drive unit)

SOC: state of charge

SOC1: first value

SOC2: second value

Tbat: battery temperature (temperature)

Tbat3: third predetermined temperature (predetermined temperature)

W: cooling water (coolant)

What is claimed is:

1. A control device of a vehicle cooling device including a drive-unit-cooling circuit cooling a drive unit with a flowing coolant, a storage-battery-cooling circuit cooling a storage battery with a flowing coolant, and a heat exchanger cooling the coolant returning from the drive-unit-cooling circuit and the coolant returning from the storage-battery-cooling circuit, the vehicle cooling device sending out the coolant cooled by the heat exchanger to the drive-unit-cooling circuit and the storage-battery-cooling circuit, wherein
when the storage battery is in a charging state, a flow of the coolant flowing through the drive-unit-cooling circuit is stopped.

2. The control device of the vehicle cooling device according to claim 1, wherein when the storage battery is in a non-charging state and a state of charge of the storage battery is equal to or less than a first value set in advance, the flow of the coolant flowing through the drive-unit-cooling circuit is stopped.

3. The control device of the vehicle cooling device according to claim 2, wherein when the storage battery is in the non-charging state and the state of charge of the storage battery is greater than the first value and equal to or less than a second value set in advance to be greater than the first value, the coolant is circulated in the drive-unit-cooling circuit.

4. The control device of the vehicle cooling device according to claim 1, wherein when the storage battery is in the non-charging state and the temperature of the storage battery is equal to or greater than a predetermined temperature set in advance, the flow of the coolant flowing through the drive-unit-cooling circuit is stopped.

5. The control device of the vehicle cooling device according to claim 1, wherein the coolant is a cooling water.

6. The control device of the vehicle cooling device according to claim 1, wherein
the vehicle cooling device includes a first pump sending out the coolant cooled by the heat exchanger into the drive-unit-cooling circuit and a second pump sending out the coolant cooled by the heat exchanger into the storage-battery-cooling circuit, and wherein
when the storage battery is in the charging state, the first pump is stopped to stop the flow of the coolant in the drive-unit-cooling circuit.

7. The control device of the vehicle cooling device according to claim 6, wherein when the storage battery is in the non-charging state and the state of charge of the storage battery is greater than a first value set in advance and equal to or less than a second value set in advance to be greater than the first value, the first pump is driven to circulate the coolant in the drive-unit-cooling circuit.
